(19) United States
(12) Patent Application Publication
(10) Pub. No.: US 2010/0289183 A1
(43) Pub. Date: Nov. 18, 2010

(54) MANUFACTURING METHOD AND MANUFACTURING APPARATUS FOR PATTERNED MEDIA

(75) Inventors: Koji TSUSHIMA, Kamisato (JP); Naoaki YAMASHITA, Kamisato (JP); Noritake SHIZAWA, Kamisato (JP); Kyoichi MORI, Kamisato (JP)

Correspondence Address: BRUNDIDGE & STANGER, P.C., 2318 MILL ROAD, SUITE 1020, ALEXANDRIA, VA, 22314, US

(73) Assignee: HITACHI HIGH-TECHNOLOGIES CORPORATION, Tokyo (JP)

(21) Appl. No.: 12/775,573

(22) Filed: May 7, 2010

(30) Foreign Application Priority Data
May 18, 2009 (JP) 2009-120158

(51) Int. Cl. B28B 11/08

(52) U.S. Cl. 264/293; 425/385

(57) ABSTRACT

The present invention includes the steps of: applying resist to a surface of a disk base material mounted on a base; mounting a stamper on the resist, wherein the stamper includes not only an area larger than the disk base material but also a concavo-convex region between chamfered sections for an inner-diameter section and an outer-diameter section of the disk base material; mounting an elastic plate on the stamper, wherein the elastic plate includes an inner-diameter section and an outer-diameter section smaller than chamfered sections of the inner-diameter section and the outer-diameter section of the disk base material and larger than the concavo-convex region of the stamper; mounting a pressing member on the elastic plate and pressing the elastic plate toward the disk base material; exposing the resist and etching the disk base material using the exposed resist as a mask; and removing the remaining resist from the disk base material.

### BACKGROUND OF THE INVENTION

The present invention relates to a manufacturing method and a manufacturing apparatus for patterned media using the nanoimprint technology.

In recent years, hard disks are increasingly used for various products including not only servers and computers but also home-use hard disk recorders, car navigation systems, and portable audio-visual players. The hard disk storage capacity tends to increase in accordance with digitization in various applications.

Increasing the storage capacity is equivalent to increasing the recording density of disks as a media. For example, the patterned media technology increases the recording density of disk media and is expected to be positively used in the future. As shown in FIG. 4, patterned media include a discrete track medium and a bit patterned medium. A discrete track media technique is illustrated at the left and forms a concentric track pattern on a disk medium 10. A bit patterned media technique is illustrated at the right and forms numerous bit patterns 16.

Conventionally, a magnetic thin film is formed on a disk surface and is later divided into regions each corresponding to one bit. The regions are magnetized to record data. The patterned media technology forms the above-mentioned magnetic pattern on the disk surface and records magnetized information on the formed pattern. A space is provided between adjacent patterns to magnetically insulate the patterns. This makes it possible to provide higher recording density than conventional contiguous magnetic thin film media.

The nanoimprint technology is expected to be a mainstream method for forming patterns. FIG. 5 illustrates the nanoimprint technology. A light transmissive stamper mold 19 is prepared (a). The stamper 19 is pressed against resist 18 applied to the surface of a disk substrate 12 where a magnetic film is formed (b). In this state, the resist 18 is exposed (c). The stamper 19 is removed (d). The disk substrate is etched (e) to form a track pattern 14 or a bit pattern 16 (f).

Translation of Unexamined PCT Application 2007-535172 discloses the configuration that can transfer patterns to a non-flat surface. According to the configuration, a template used for the nanoimprint technology is provided with an elastomer layer between an imprinting layer formed with a relief image and a rigid transparent substrate.

### SUMMARY OF THE INVENTION

The above-mentioned system is used for pattern transfer in a vacuum chamber under reduced pressure. Improved throughput is mandatory for a process that aims at pattern transfer for mass production. The pattern transfer in a vacuum chamber may degrade the throughput.

As another problem, bubbles may be mixed when the above-mentioned system transfers a pattern in the atmosphere. This phenomenon occurs when an air pressure is applied to the stamper that is then pressed against the disk surface. A stress concentrates at the stamper edge in contact with the disk surface. The problem needs to be solved.

The present invention provides a patterned media manufacturing method free from mixed bubbles and defects when a pattern is transferred in the atmosphere.

Further, the invention provides a patterned media manufacturing apparatus capable of applying a uniform stamper pressure to a targeted imprint region without concentrating a stress at a stamper contact edge when the stamper is pressed against a disk base material in the atmosphere.

The present invention embodies a method of manufacturing patterned media including the steps of: mounting a disk base material on a base, wherein a chamfered section is provided for an inner-diameter section and an outer-diameter section of the disk base material; applying resist to a surface of the disk base material; mounting a stamper on the resist, wherein the stamper includes not only an area larger than the disk base material but also a concavo-convex region between the chamfered sections for the inner-diameter section and the outer-diameter section of the disk base material; mounting an elastic plate on the stamper, wherein the elastic plate includes an inner-diameter section and an outer-diameter section smaller than chamfered sections of the inner-diameter section and the outer-diameter section of the disk base material and larger than a concavo-convex region of the stamper; mounting a pressing member on the elastic plate; pressing the elastic plate toward the disk base material through the pressing member; exposing the resist through the pressing member, the elastic plate, and the stamper; removing the pressing member, the elastic plate, and the stamper from the disk base material; etching the disk base material using the exposed resist as a mask; and removing the remaining resist from the disk base material.

The elastic plate is preferably made of polymer resin having a high ultraviolet transmission rate.

The elastic plate is preferably made of silicon rubber indicating a Young's modulus of 2.5 to 8 Mpa and a Poisson's ratio of 0.4 to 0.5.

The invention embodies a patterned media manufacturing apparatus including: a base for mounting a disk base material; a stamper that is mounted on resist applied to the disk base material, includes an area larger than the disk base material, and is provided with a concavo-convex region between chamfered sections for an inner-diameter section and an outer-diameter section of the disk base material; an elastic plate that is mounted on the stamper and includes an inner-diameter section and an outer-diameter section smaller than chamfered sections of the inner-diameter section and the outer-diameter section of the disk base material and larger than the concavo-convex region of the stamper; a pressing member mounted on the elastic plate; pressing means for applying a uniform thrust force to the pressing member; means for exposing the resist through the pressing member, the elastic plate, and the stamper; and means for etching the disk base material using the exposed resist as a mask.

The elastic plate is preferably made of polymer resin having a high ultraviolet transmission rate.

The elastic plate is preferably made of silicon rubber indicating a Young's modulus of 2.5 to 8 Mpa and a Poisson's ratio of 0.4 to 0.5.

The invention can provide a method of manufacturing defect-free patterned media. The invention can also provide a patterned media manufacturing apparatus that can apply a uniform stamper pressing force to a targeted imprint region without concentrating a stress on the disk base material at the edge in contact with the stamper.

These and other objects, features and advantages of the invention will be apparent from the following more particular description of a preferred embodiment of the invention, as illustrated in the accompanying drawings.

### BRIEF DESCRIPTION OF THE DRAWINGS

FIG. 1 is a schematic sectional view of a patterned media manufacturing apparatus so as to illustrate a manufacturing method and a manufacturing apparatus for patterned media according to an embodiment of the invention;

FIG. 2 is an enlarged sectional view of portion A in FIG. 1;

FIG. 3 is a chart showing distribution of pressures on a disk substrate surface in accordance with different elastic plate sizes used for the patterned media manufacturing apparatus according to the embodiment of the invention;

FIG. 4 schematically shows patterned media; and

FIGS. 5A to 5F show a manufacturing process for patterned media.

### DESCRIPTION OF THE PREFERRED EMBODIMENTS

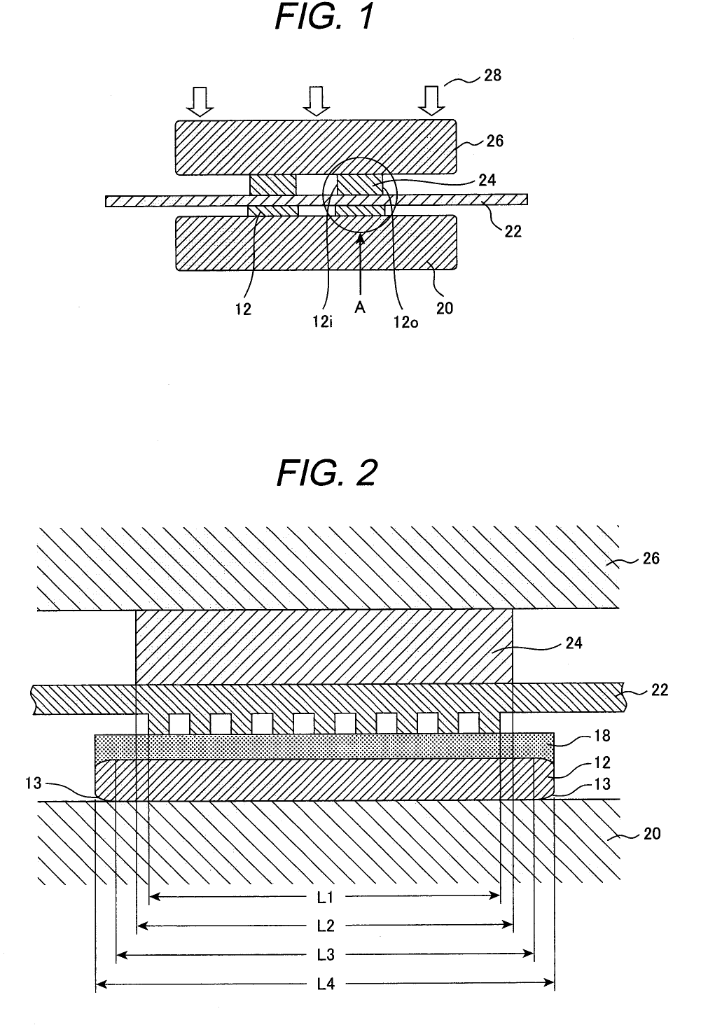

With reference to FIGS. 1 and 2, the following describes the patterned media manufacturing apparatus according to the embodiment of the invention. As shown in FIGS. 1 and 2, the patterned media manufacturing apparatus includes: a base 20; a stamper 22 having a concavo-convex pattern region; an elastic plate 24 provided with an inner-diameter section 12i and an outer-diameter section 12o; a pressing member 26; and pressing means 28 for applying a vertical load to the pressing member 26. The concavo-convex pattern is to be transferred to a disk base material 12 that is placed on the base. Resist 18 is applied onto the disk base material 12. The concavo-convex pattern of the stamper 22 is pressed against the disk base material 12 through the resist 18. Thought not shown, the patterned media manufacturing apparatus further includes means for using ultraviolet light to expose the resist 18 through the pressing member 26, the elastic plate 24, and the stamper 22. After the resist 18 is exposed, the stamper 22, the elastic plate 24, and the pressing member 26 are removed. The apparatus also includes means for etching the disk base material 12 using the exposed resist as a mask. The apparatus further includes means for removing the remaining resist after etching.

The disk base material 12 includes a magnetic recording medium formed on a substrate and is provided with chamfered sections 13 at chamfered portions of the inner-diameter section 12i and the outer-diameter section 12o.

In the patterned media manufacturing apparatus, the pressing member 26 uses quartz having a high ultraviolet transmission rate. The pressing member 26 is sufficiently larger than the elastic plate 24 placed below. The pressing member 26 is thick enough to ensure mechanical strength. So as to be able to accurately transmit loads, the pressing member 26 has a high surface accuracy and indicates the surface roughness of approximately ½λ. A vertical load of approximately 0.1 MPa is applied to the pressing member 26. A uniform thrust force is applied to the pressing member 26 so that the imprint region (concavo-convex pattern region) of the stamper 22 can apply a uniform stamper pressing force.

The stamper 22 uses quartz or glass to provide a high ultraviolet transmission rate. The stamper 22 has a larger area than the disk base material 12. The stamper 22 is as thick as 0.5 to 0.8 mm. Dimension L1 is applied to the concavo-convex pattern region formed on the stamper 22 and needs to be smaller than dimension L4 for the disk base material 12 including inner and outer diameters. The shape of the elastic plate 24 determines a pattern region that can be transferred based on uniform pressure distribution.

Dimension L2 of the elastic plate 24 needs to be smaller than dimension L4 of the disk base material 12 including the inner-diameter section 12i and the outer-diameter section 12o. Dimension L2 needs to be smaller than dimension L3 between the chamfered sections 13 provided for the inner-diameter section 12i and the outer-diameter section 12o of the disk base material 12. Dimension L2 needs to be larger than dimension L1 of the concave-convex pattern region of the stamper 22. When transferring a pattern, the elastic plate 24 needs to be placed above the pattern region of the stamper 22. The elastic plate 24 needs to be as thick as approximately 5 mm. The elastic plate 24 is made of polymer resin indicative of a high ultraviolet transmission rate. The surface of the elastic plate 24 ensures high surface accuracy. For example, the elastic plate 24 may be made of highly transparent silicon rubber that indicates a Young's modulus of approximately 2.5 to 8 Mpa and a Poisson's ratio of 0.4 to 0.5. High-quality silicon rubber can be molded and duplicated from a formed part.

The base portion 20 is made of quartz or stainless steel (SUS) so as to ensure mechanical strength against a vertical load. The base portion 20 needs to be sized larger than the disk base material 12. The surface of the base portion 20 contacts with the disk base material 12 and needs to ensure high surface accuracy.

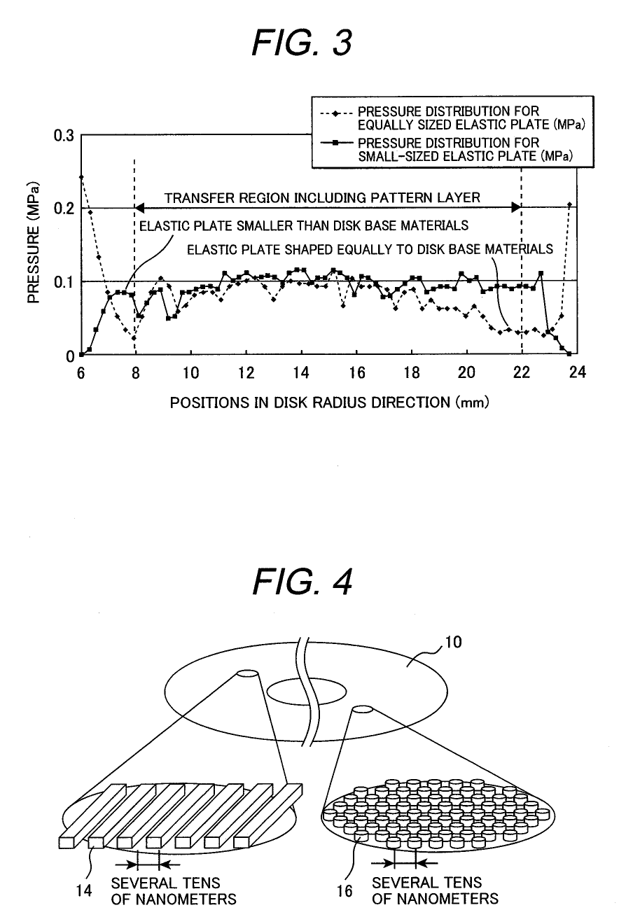

FIG. 3 shows pressure distribution on the surface of the disk base material under the condition that the elastic plate 24 is sized to be equal to and smaller than the disk base material 12. In FIG. 3, the horizontal axis indicates positions in the disk radius direction. The vertical axis indicates pressures. As shown in FIG. 3, the pressure applied to the disk base material surface varies with the shape of the elastic plate 24 on the stamper 22. When the elastic plate 24 is sized to be equal to the disk base material 12, a stress concentrates due to contact with the chamfered section 13 of the disk base material. When a stress concentrates at the edge of the disk base material 12, the air inward from the edge is not exhausted and is trapped to generate bubbles inside. When bubbles are generated, the stamper 22 degrades the transfer quality and may become defective.

When the elastic plate 24 is sized to be smaller than the disk base material 12 as shown in FIG. 3, the pressure distribution becomes uniform without stress concentration at the disk edge. The pressure can be uniformly distributed when the elastic plate 24 is optimally smaller than the disk base material 12.

The flexible elastic plate 24 and the thin stamper 22 provide another factor that prevents stress concentration near the edge of the disk base material surface. When a load is applied to the pressing member 26, a reactive force is generated at the edge of the elastic plate 24. The edge of the elastic plate 24 is greatly deformed at the surface in contact with the stamper 22 because the elastic plate 24 features the sufficiently high Poisson's ratio. As a result, the reactive force at the edge is used to deform the elastic plate 24, preventing the stress concentration.

Because the stamper 22 is thin, it can press the disk base material surface without uniformly distributing the stress due to deformation of the elastic plate 24. When the stamper 22 is thick, its rigidity causes the stress distribution resulting from deformation of the elastic plate 24 to be a homogeneous pressing force. As a result, the stress concentrates on the disk base material surface near the edge of the stamper 22.

As mentioned above, the patterned media manufacturing apparatus can press the stamper against the disk base material by uniformly distributing the pressure without concentrating a stress at the edge of the disk base material.

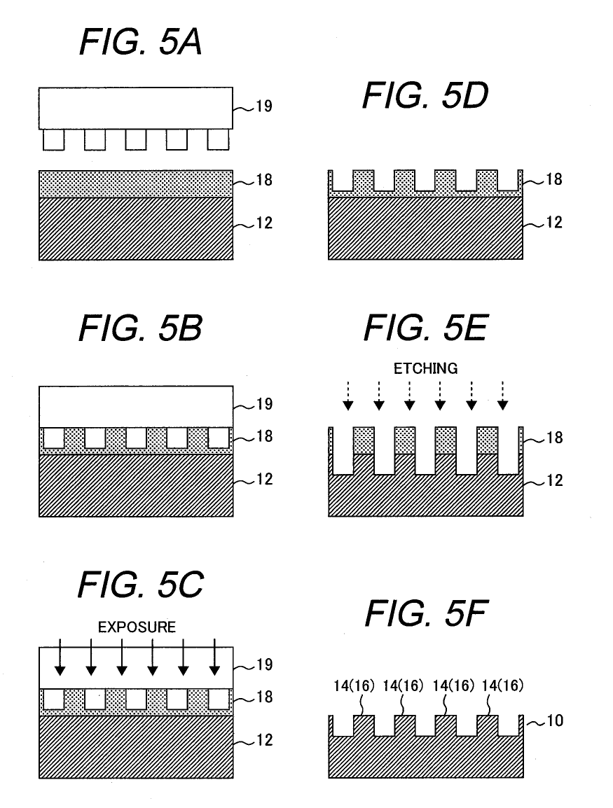

With reference to FIGS. 1, 2, and 5A to 5F, the following describes a method of manufacturing patterned media using the above-mentioned patterned media manufacturing apparatus. The disk base material 12 is placed on the quartz base 20. A pattern is to be transferred to the disk base material 12. The resist 18 is applied to the disk base material 12 in accordance with a spin-on dielectric technology. The stamper 22 includes a concavo-convex pattern region and has a larger area than the disk base material 12. The stamper 22 is placed above the resist 18 so that the concavo-convex pattern region corresponds to the disk base material 12. The elastic plate 24 is placed above the pattern region of the stamper 22. The elastic plate 24 has dimension L2 that is smaller than L3 between the chamfered sections 13 provided for the inner-diameter section 12i and the outer-diameter section 12o of the disk base material 12 and is larger than dimension L1 of the concavo-convex pattern region on the stamper 22. The quartz pressing member 26 is placed on the elastic plate 24. The pressing means 28 applies a vertical load of approximately 0.1 MPa to the pressing member 26. A uniform thrust force is applied to the pressing member 26 so that a more uniform stamper pressing force is applied to the imprint region (concavo-convex pattern region) of the stamper 22. At this time, the concavo-convex pattern region of the stamper 22 and the resist 18 maintain the state as shown in FIG. 5B. Exposure means uses ultraviolet light to expose the resist 18 through the pressing member 26, the elastic plate 24, and the stamper 22 (see FIG. 5C). The stamper 22, the elastic plate 24, and the pressing member 26 are removed (see FIG. 5D). The exposed resist 18 is used as a mask to etch the disk base material 12 (see FIG. 5E). The remaining resist is removed from the disk base material (see FIG. 5F). In this manner, the patterned-media disk 10 is completed.

The above-mentioned manufacturing method can apply a uniform stamper pressing force to a targeted imprint region without concentrating a stress on the disk base material at the edge in contact with the stamper. The manufacturing method can manufacture defect-free patterned media. The manufacturing method can manufacture patterned media in the atmosphere and is therefore capable of mass production.

The present invention is applicable to the manufacturing method and the manufacturing apparatus for patterned media as high-density recording media.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of manufacturing patterned media comprising the steps of:
mounting a disk base material on a base, wherein a chamfered section is provided for an inner-diameter section and an outer-diameter section of the disk base material;
applying resist to a surface of the disk base material;
mounting a stamper on the resist, wherein the stamper includes not only an area larger than the disk base material but also a concavo-convex region between the chamfered sections for the inner-diameter section and the outer-diameter section of the disk base material;
mounting an elastic plate on the stamper, wherein the elastic plate includes the dimension between an inner-diameter section and an outer-diameter section smaller than the dimension between the chamfered sections of the inner-diameter section and the outer-diameter section of the disk base material and larger than a concavo-convex region of the stamper;
mounting a pressing member on the elastic plate;
pressing the elastic plate toward the disk base material through the pressing member;
exposing the resist through the pressing member, the elastic plate, and the stamper;
removing the pressing member, the elastic plate, and the stamper from the disk base material;
etching the disk base material using the exposed resist as a mask; and
removing the remaining resist from the disk base material.

2. The patterned media manufacturing method according to claim 1, wherein the elastic plate is made of polymer resin having a high ultraviolet transmission rate.

3. The patterned media manufacturing method according to claim 1, wherein the elastic plate is made of silicon rubber indicating a Young's modulus of 2.5 to 8 Mpa and a Poisson's ratio of 0.4 to 0.5.

4. A patterned media manufacturing apparatus comprising:
a base for mounting a disk base material;
a stamper that is mounted on resist applied to the disk base material, includes an area larger than the disk base material, and is provided with a concavo-convex region between chamfered sections for an inner-diameter section and an outer-diameter section of the disk base material;
an elastic plate that is mounted on the stamper and includes the dimension between an inner-diameter section and an outer-diameter section smaller than the dimension between the chamfered sections of the inner-diameter section and the outer-diameter section of the disk base material and larger than the concavo-convex region of the stamper;
a pressing member mounted on the elastic plate;
pressing means for applying a uniform thrust force to the pressing member;
means for exposing the resist through the pressing member, the elastic plate, and the stamper; and
means for etching the disk base material using the exposed resist as a mask.

5. The patterned media manufacturing apparatus according to claim 4, wherein the elastic plate is made of polymer resin having a high ultraviolet transmission rate.

6. The patterned media manufacturing apparatus according to claim 4, wherein the elastic plate is made of silicon rubber indicating a Young's modulus of 2.5 to 8 Mpa and a Poisson's ratio of 0.4 to 0.5.
